(19) United States
(12) Patent Application Publication
(10) Pub. No.: US 2005/0045682 A1
(43) Pub. Date: Mar. 3, 2005

(54) Organizer for storage space in an automobile

(76) Inventors: Christopher F. Tarrant, Truro (CA); Robert S. Briggs, Dartmouth (CA); Michael T. Book, Sackville (CA); Patrick T. Ryan, Halifax (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/891,115

(22) Filed: Jul. 15, 2004

Related U.S. Application Data
(60) Provisional application No. 60/486,890, filed on Jul. 15, 2003.

(51) Int. Cl. A47B 88/00; A47B 95/00; B60R 9/00; B60R 11/00; B60R 7/00

(52) U.S. Cl. 224/498; 224/543

(57) ABSTRACT

The present invention is a collapsible organizer for dividing a vehicle storage area of a vehicle into at least two storage compartments comprising a base; a fixed wall; a divider wall, pivotally mounted to the base for rotation between a stored position against the base and an upright position spaced apart from and generally parallel to the fixed wall; at least two partitions extending between the fixed wall and the divider wall; and means for locking the divider wall in the upright position.

### CROSS REFERENCE TO RELATED APPLICATIONS

This application claims the benefit of U.S. Provisional Application No. 60/486,890, filed Jul. 15, 2003, which is incorporated herein by reference.

### FIELD OF THE INVENTION

The present invention relates generally to automobiles. More particularly, the present invention relates to an organizer for storage space in an automobile.

### BACKGROUND OF THE INVENTION

Cargo management is a growing automotive industry trend leading to many exciting products. Sedan trunk organization is one area of focus. Today many vehicles have an “envelope net” to contain items stored in the trunk, as well as unique side pockets and compartments. Although somewhat useful both have limitations resulting in the desire for a more improved organizational product. Although the prior art envelope net storage alternative is low cost, it is difficult to place items such as grocery bags within the net with only one hand such that both hands are sometimes necessary. Furthermore, the envelope net is limited to the weight of objects that can be contained and has limited flexibility of divided storage spaces.

It is, therefore, desirable to provide an improved organizer for storage area in an automobile which overcomes some of the disadvantages of the prior art.

### SUMMARY OF THE INVENTION

It is an object of the present invention to obviate or mitigate at least one disadvantage of previous organizers for storage space in an automobile.

The organizer of the present invention includes improved features that have a high customer appeal. In one embodiment, a narrow front to back product provides improved organization for confined storage spaces such as the trunks of SUV's and vans with a small confined cargo area. This is typically the case when a third row seat is installed.

Furthermore, the divider wall of the organizer is collapsible when in a stored position therefore taking up very little of the or no storage space so that large items such as golf clubs and luggage can then be stored in the storage space. The organizer may also contain heavier items such as milk jugs without breaking.

Furthermore, the organizer is designed for one-handed use or an easy to operate two-handed motion.

In one embodiment, the organizer is secured to the rear trunk wall in a sedan or potentially under the sill plate molding in a narrow back SUV or a van and is easily detached should access to the spare tire well be required.

In one aspect of the present invention, there is provided a collapsible organizer for dividing a vehicle storage area of a vehicle into at least two storage compartments comprising a base; a fixed wall; a divider wall, pivotally mounted to the base for rotation between a stored position against the base and an upright position spaced apart from and generally parallel to the fixed wall; at least two partitions extending between the fixed wall and the divider wall; and means for locking the divider wall in the upright position.

In another aspect of the present invention, there is provided a collapsible organizer for dividing a vehicle storage area into at least two storage compartments comprising a base having hinges for rotation between a stored position and an in use position; a fixed wall; a divider wall, mounted to the base; means for connecting the base to the vehicle storage area; and at least two partitions extending between the fixed wall and the divider wall; wherein when the organizer is in the in use position, the divider wall is spaced apart from and generally parallel to the fixed wall and when the organizer is in the stored position the divider wall is adjacent the base and the fixed wall.

Features of the invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIGS. 1a to 1f are schematic diagrams of a first embodiment of an organizer for storage space in an automobile.

FIGS. 2a to 2e are schematic diagrams of a second embodiment of the organizer.

FIGS. 3a to 3e are schematic diagrams of a third embodiment of the organizer.

FIGS. 4a to 4b are schematic diagrams of a fourth embodiment of the organizer.

FIGS. 5a to 5b are side views of methods of fastening the organizer to a vehicle.

FIGS. 6a to 6f are schematic diagrams of a fifth embodiment of the organizer.

FIG. 6g is a schematic diagram of a cable actuated locking hinge system.

FIGS. 7a to 7b are schematic diagrams of a sixth embodiment of the organizer.

FIGS. 8a to 8d are schematic diagrams of yet another embodiment of the organizer.

FIGS. 9a to 9d are schematic diagrams of a further embodiment of the organizer.

FIGS. 10a to 10d are schematic diagrams of another embodiment of the organizer.

FIGS. 11a to 11d are schematic diagrams of a further embodiment of the organizer for use under a cab seat.

FIGS. 12a to 12c are schematic diagrams of yet another embodiment of the organizer.

### DETAILED DESCRIPTION

Generally, the present invention provides apparatus for an organizer for storage space in an automobile.

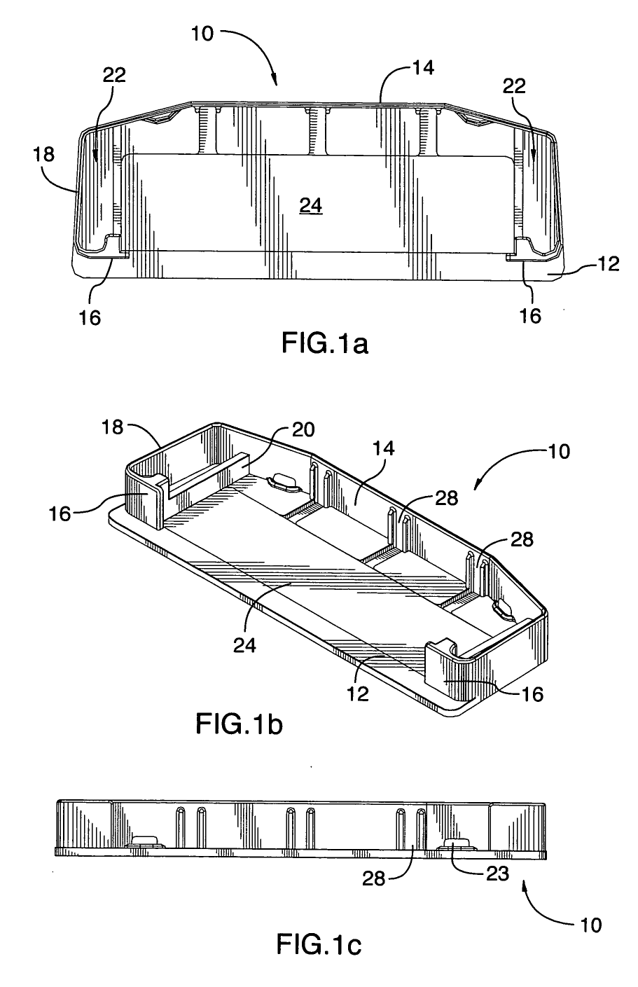

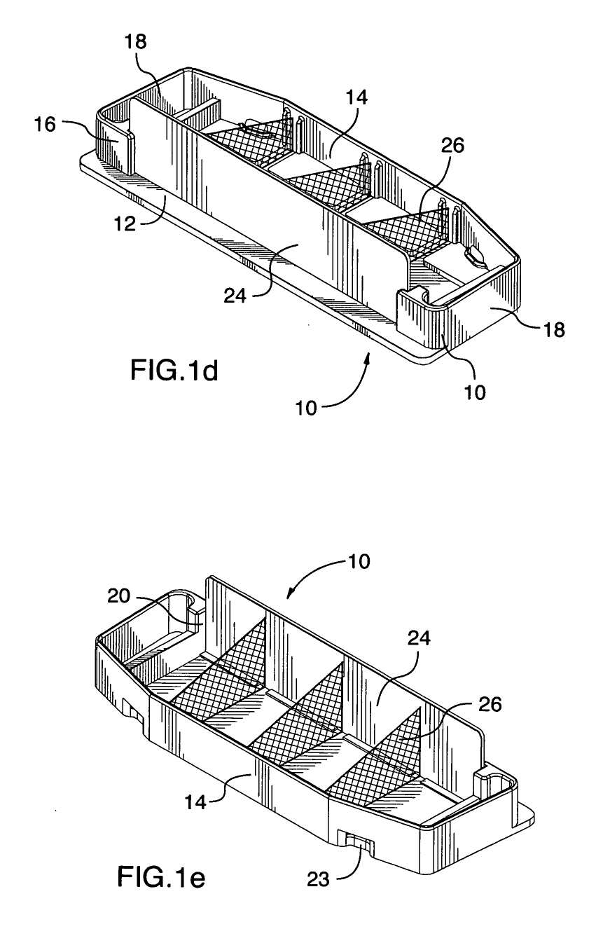

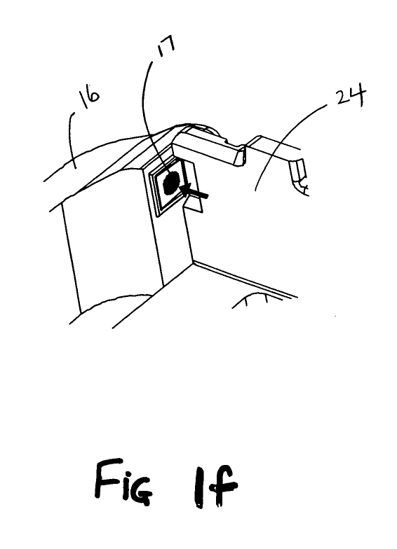

Turning to FIGS. 1a to 1f, a first embodiment of an organizer for storage space in an automobile is shown. This embodiment is preferably manufactured for use in a trunk of an automobile such as a sedan and is preferably integrated/attached with the rearward perimeter of the trunk. FIG. 1a is a top plan view of the organizer, while FIG. 1b is a perspective view of the organizer in a stored position and FIG. 1c is a front view of the organizer in the stored position. FIG. 1d is a perspective front view of the organizer in an in use position and FIG. 1e is a perspective rear view of the organizer in the in use position. The organizer 10 comprises a base 12, which is elongated in this embodiment, with a fixed wall 14 along the long end of one side of the base 12. The fixed wall 14 is connected to a pair of support pillars 16 via a pair of side walls 18. The support pillars 16 also include a moulded section 20 which connects to the fixed wall 14 to provide side pockets 22 for the organizer 10. The organizer 10 also preferably includes cargo hook access areas 23 for existing vehicle cargo hook access. The organizer 10 further comprises a divider wall 24 which is in an upright position for containing items within the organizer when the organizer is in the in use position as shown in FIG. 1d and stores flat to the base when in the stored position as shown in FIG. 1b. When in the in use position, the divider wall 24 is spaced apart from and generally parallel to the fixed wall 14. In order for the divider wall 24 to move from the stored position to the in use position and vice versa, the divider wall 24 is pivotally mounted or slotted into the base 12.

Detachable partitions 26, preferably made of netting, allow for varying sized compartments within the organizer. The partitions 26 are preferably attached at predefined locations 28 located on the fixed wall 14 and the divider wall 24. This allows for a plurality of compartments to be available within the organizer so that items such as groceries and anti-freeze may be stored separately. The support pillars 16 assist in supporting the divider wall 24 when the divider wall is in the upright position and may also be used to provide an attachment location for the detachable partitions. In the present embodiment, in the in use position, the organizer 10 includes means for keeping the divider wall in an upright position when in the in use position, seen as a pair of snap clips which are located on the side pillars adjacent the divider wall (which is more clearly shown in FIG. 1f). In operation, the divider wall 24 is pivoted from the stored position to the in use position past the snap clip 17 which holds the divider wall in the upright position until a user depresses the snap clip to release the divider wall 24 allowing the wall to pivot back to the stored position. It will be understood that the circumference of the fixed wall 14 and the side walls 18 preferably match the contour of the trunk of the automobile in order to maximize the amount of storage space in the trunk when the organizer is in the stored position.

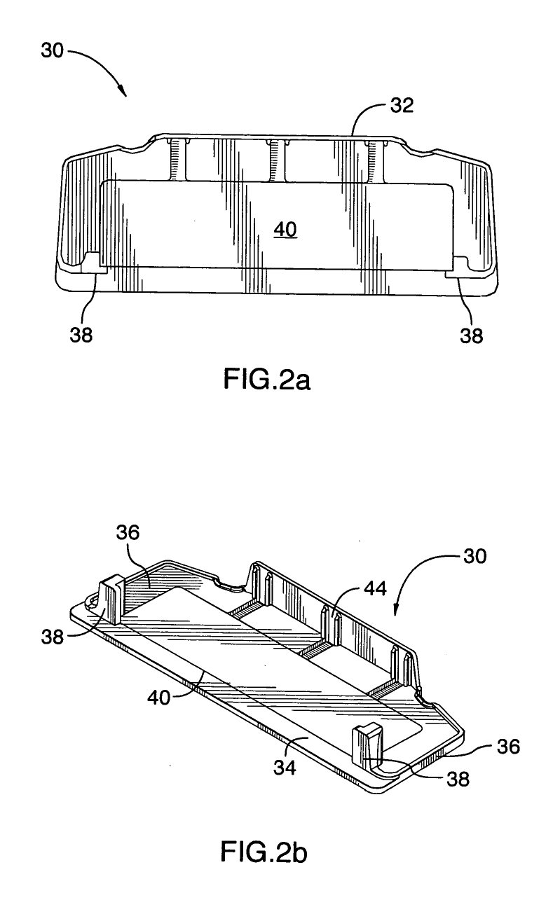

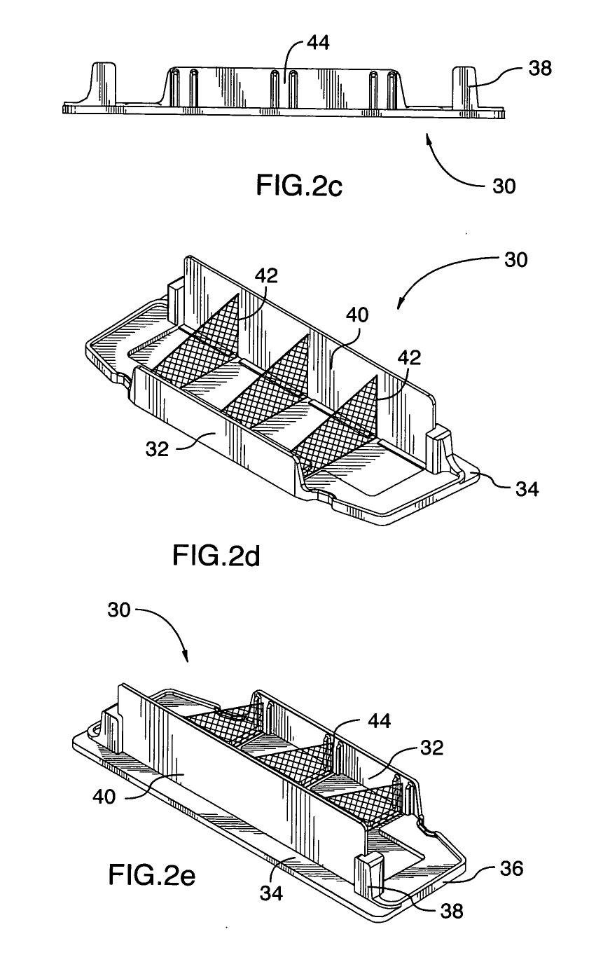

Turning to FIGS. 2a to 2e, a second embodiment of an organizer is shown. The organizer is similar to the embodiment of FIGS. 1a to 1e, but is geared for automobiles with short trunk widths since a narrow trunk opening limits installation capability. FIG. 2a is a top plan view of the organizer, while FIG. 2b is a perspective view of the organizer in a stored position and FIG. 2c is a front view of the organizer in the stored position. FIG. 2d is a perspective front view of the organizer in an in use position and FIG. 2e is a perspective rear view of the organizer in the in use position. The organizer 30 includes a base 34 having a fixed wall 32 which extends along the long edge of the base 34. A pair of short walls 36 connect the fixed wall 32 to a pair of support pillars 38 located opposite the fixed wall 32. The support pillars 38 are used as support to a collapsible divider wall 40 as well as to house snap clips to which the divider wall 40 is attached when in the in use position in order to keep the divider wall in an upright position. Detachable partitions 42 allow the user to vary the size of the storage compartments in the organizer. When in the stored position, the collapsible divider wall rests in a housing which in the base 34 of the organizer 30 in order to provide more storage space for a user. As with the above-described embodiment, the partitions 42 are attached to the fixed wall 32 and the divider wall 40 via predefined slots 44. In this embodiment, the partitions 42 may act as end walls for the organizer 30 of the sides of the automobile trunk may be used to enclose the storage area.

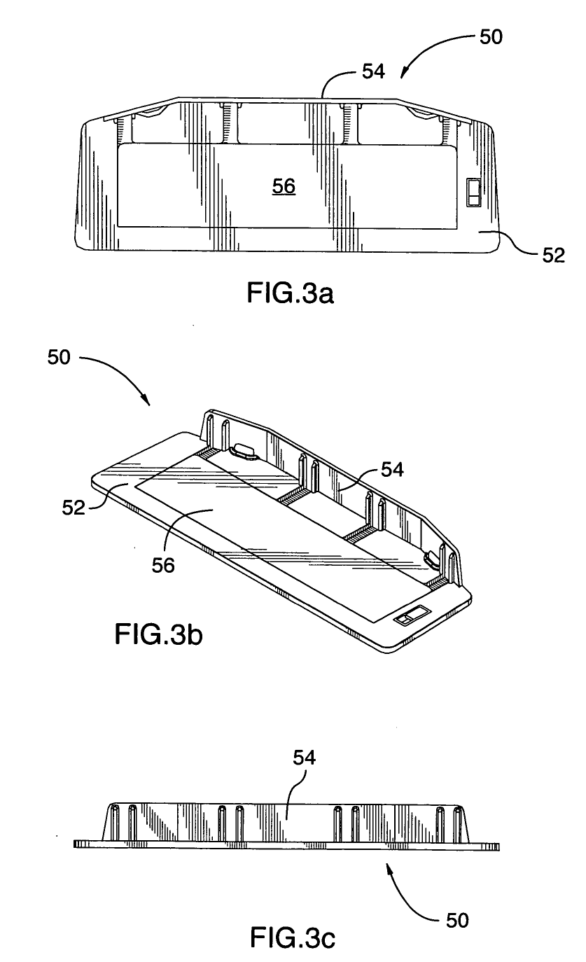

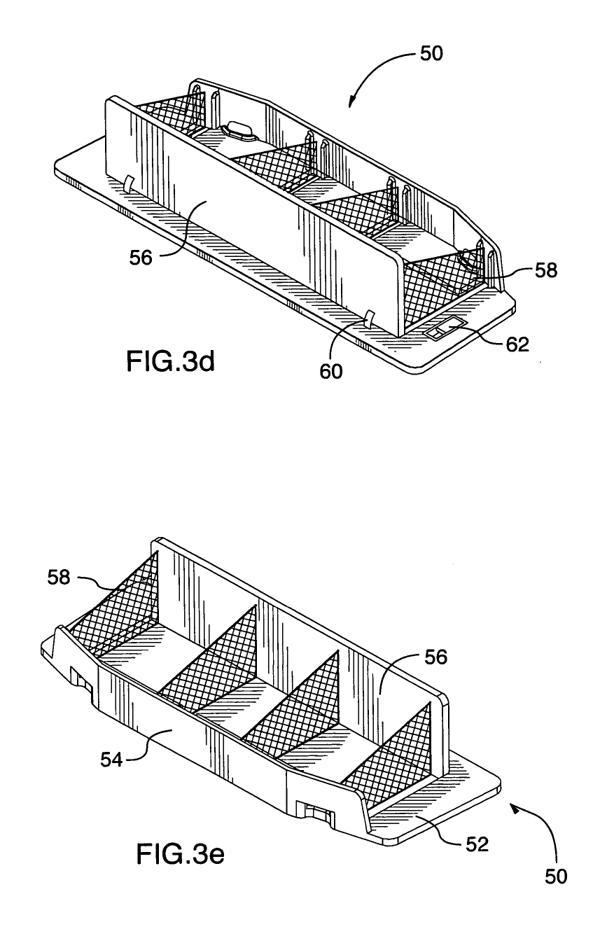

Turning to FIGS. 3a to 3e, a third embodiment of an organizer is shown. As with the embodiments of FIGS. 1 and 2, this embodiment is geared towards the storage space of an automobile trunk. In the present embodiment, a lower profile protruding into the trunk space is achieved by removing the support pillars for the divider wall. FIG. 3a is a top plan view of the organizer, while FIG. 3b is a perspective view of the organizer in a stored position and FIG. 3c is a front view of the organizer in the stored position. FIG. 3d is a perspective front view of the organizer in an in use position and FIG. 3e is a perspective rear view of the organizer in the in use position. The organizer 50 comprises a base 52 and a fixed wall 54 which is located along a long edge of the base 52 of the organizer 50. The organizer 50 further comprises a divider wall 56 which lies parallel to the base when in the stored position, as shown in FIGS. 3a to 3c and is generally parallel to and spaced apart from the fixed wall when in the in use position as shown in FIGS. 3d and 3e.

When the organizer 50 is in the in use position, at least two partitions 58 are connected between the fixed wall 54 and the divider wall 56 in order to provide an enclosed storage area. The outermost partitions 58 also serve as end walls for the organizer. Furthermore, in order to maintain the divider wall in an upright position while in use, the organizer includes means for locking 60 the divider wall in the upright position. In this embodiment, the divider wall is connected to the base via mechanical hinges. A release handle 62 for the mechanical hinges is located at a side of the organizer in order to collapse the divider wall when not in use.

As before, the number of partitions within the storage area may be determined by the user however, at least two partitions at both ends of the organizer are required to provide an enclosed storage space and to prevent any objects from falling out of the organizer storage area.

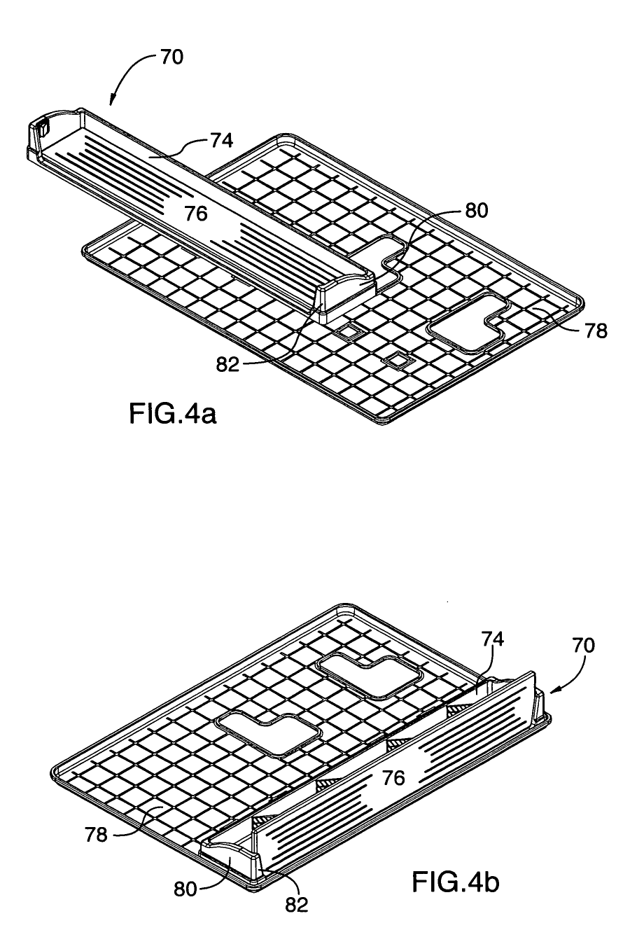

Turning to FIGS. 4a and 4b, a fourth embodiment of an organizer for storage space in an automobile is shown. This embodiment is geared towards sport utility vehicles (SUVs). In this embodiment, the organizer 70 comprises a base 72 with a fixed wall 74 located along a long edge of the base 72. A divider wall 76 is pivotally mounted to the base and is spaced apart from the fixed wall 74. The organizer 70 generally rests on the floor 78 of the SUV so that it may be easily removed and stored to the side when the organizer is not required. In this embodiment, the divider wall 76 is located at the rear of the SUV since the rear of the trunk of a SUV is narrower than the front of the trunk and has no sill wall. This is generally opposite of the design of trunks in other automobiles such as sedans. The organizer 70 also comprises a pair of side walls 80 connected to a pair of support pillars 82 to support the divider wall and to maintain the divider wall 76 in an upright position when in the in use position. Furthermore, the organizer of this embodiment has similar features to the embodiments disclosed above, but the organizer is reversed when placed in the automobile to make it more useable in a narrow backed SUV.

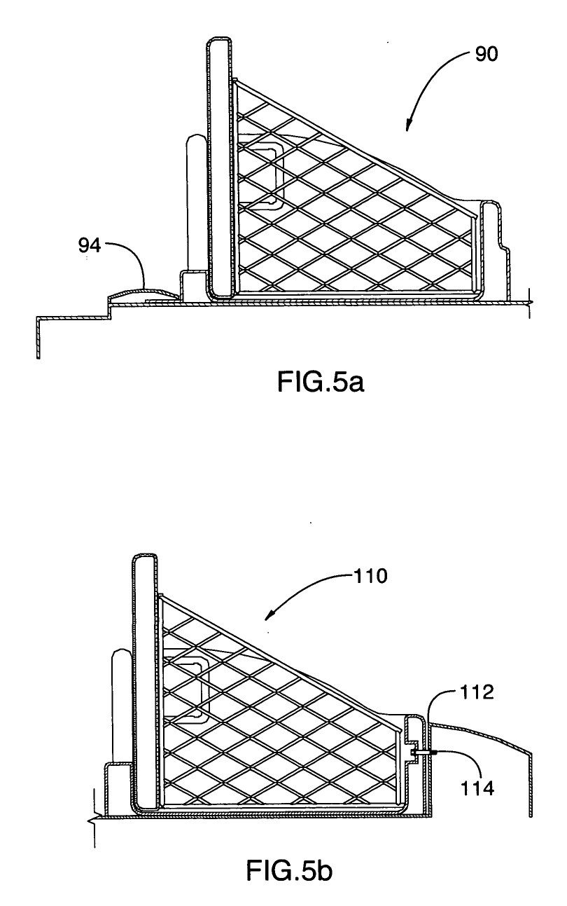

FIGS. 5a and 5b are side views of the organizer with the partitions in place. FIG. 5a illustrates a method of fastening the organizer to the under sill place attachment in an automobile, preferably an SUV while FIG. 5b illustrates a method of fastening the organizer using a push pin/fastener arrangement to the rear wall of a sedan.

In FIG. 5a, the organizer 90 is preferably connected to a sill plate of the SUV using an under sill plate attachment 94. Alternatively, the organizer 90 may be connected to the cargo hooks in the trunk.

In FIG. 5b, the organizer 110 is preferably connected to a sill plate 112 of the sedan using a push/pin fastener 114.

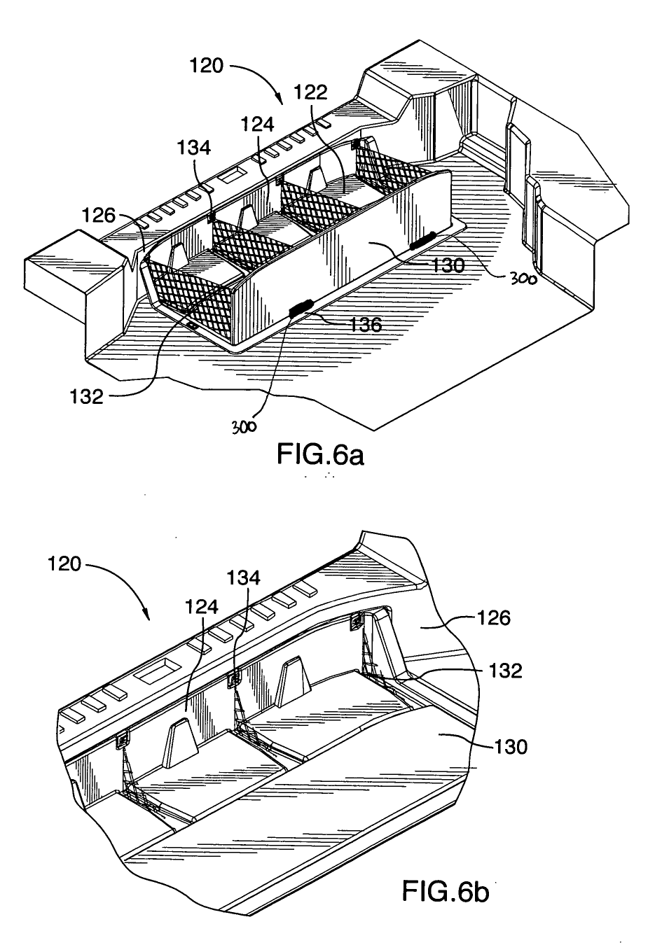

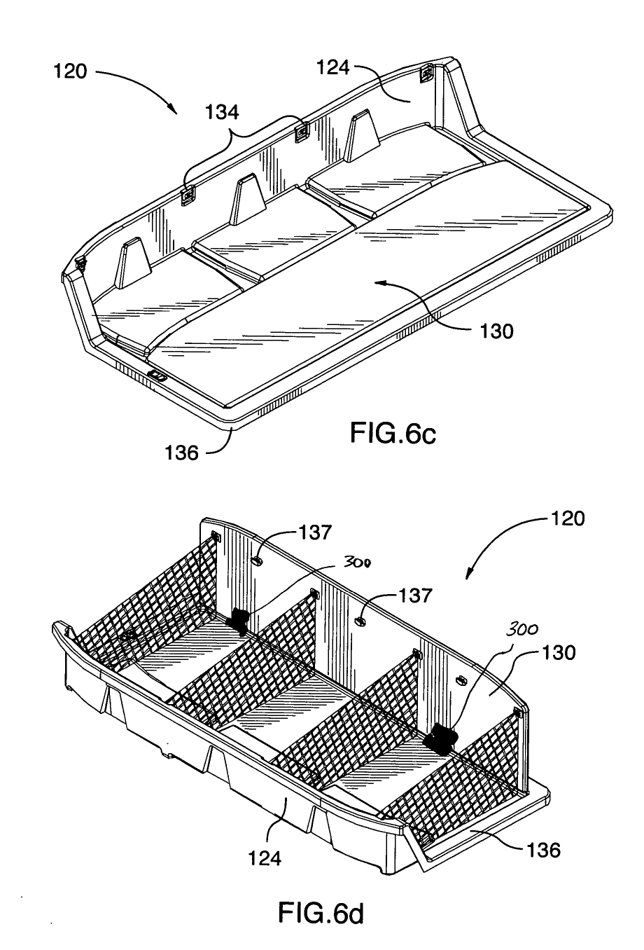

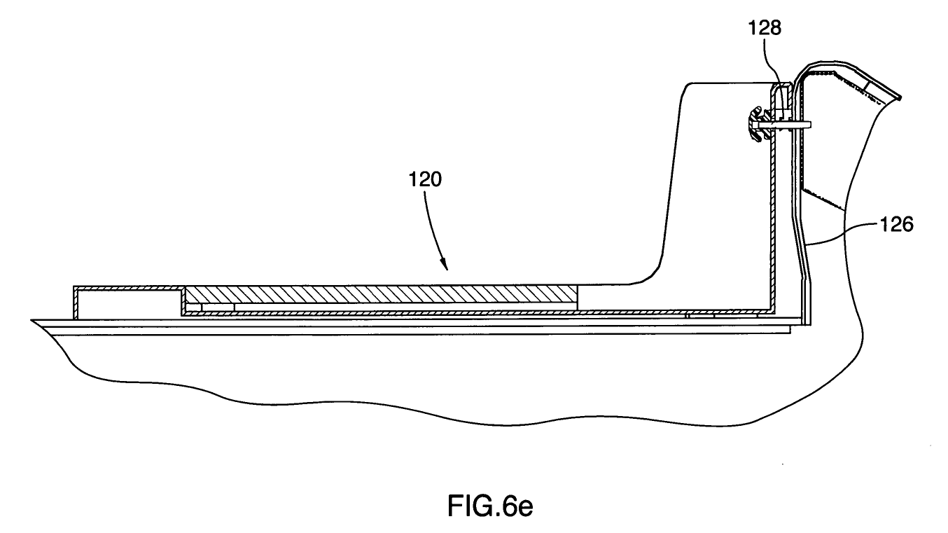

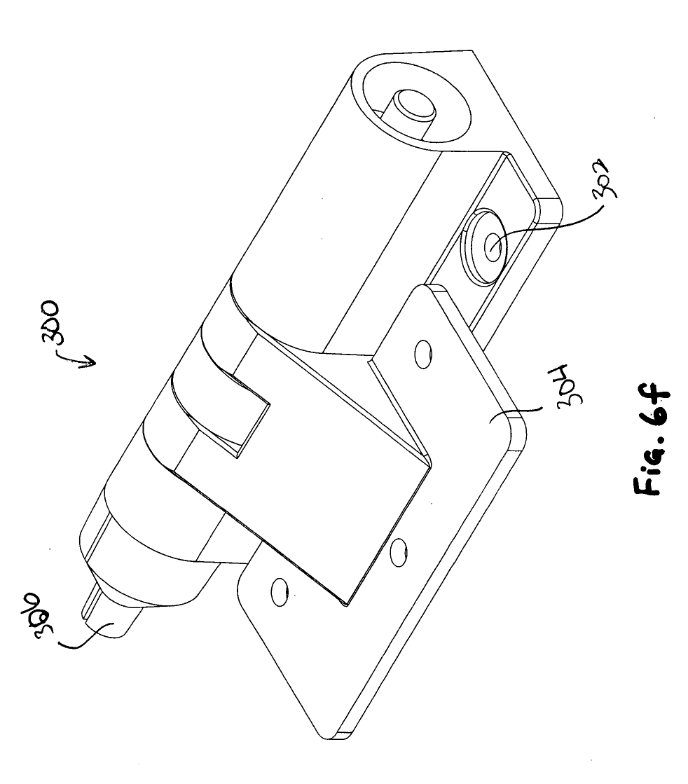

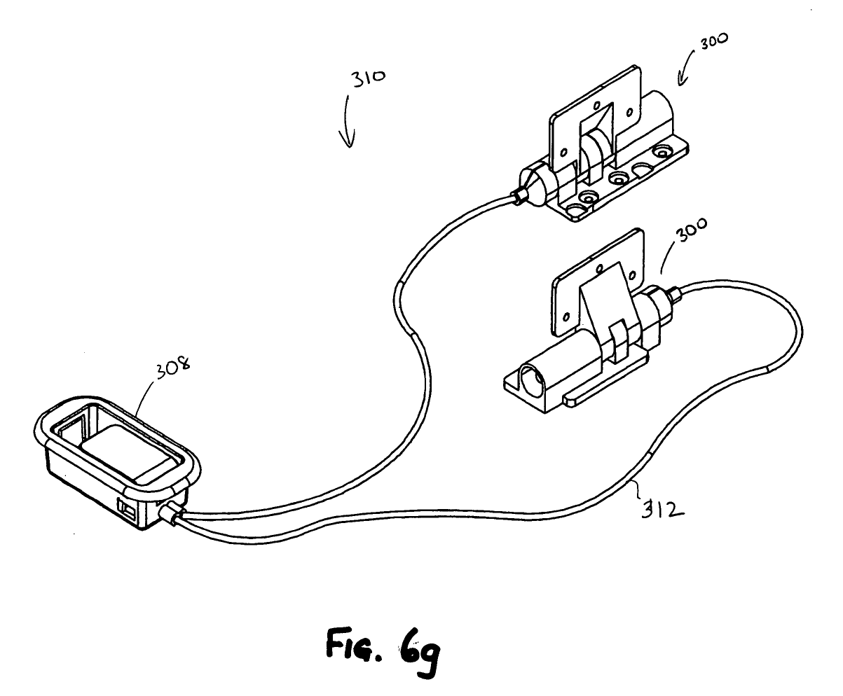

Turning to FIGS. 6a to 6f, yet another embodiment of an organizer for storage space in an automobile is shown installed in a car trunk.

The organizer 120 comprises a base 122 which rests atop the floor of the car trunk in which the organizer 120 is integrated. A fixed wall 124, substantially perpendicular to the base 122, is located along the perimeter of the base 122 along at least a long edge of the base 122. In this embodiment, the fixed wall 124 is attached to a sill plate 126 of the trunk via fastening means 128 such as a threaded fastener. This may be more clearly seen in FIG. 6e which provides a cut away side view of the installed organizer.

The organizer 120 further comprises a divider wall 130 which is located directly across from the fixed wall 124 when the organizer 120 is in the in use position, as shown in FIG. 6a. Partitions 132, preferably manufactured out of netting, are used to separate the storage space created between the fixed wall 124 and the divider wall 130 in order to provide multiple smaller storage areas in the car trunk for smaller items such as jumper cables, grocery bags, motor oil, shoes, etc. . . . The partitions are attached to hooks 134 located on the fixed wall 124 and the divider wall 130. In this embodiment, the partitions are preferably flexible so that when the organizer is in the stored position, as shown in FIG. 6b, the partitions 132 do not have to be removed but are simply folded down by the divider wall 130. The organizer 120 further includes a ridge 136 which is located along the perimeter of the base 122 to provide support to the divider wall 130. Mechanical means 300, as shown in FIGS. 6a and 6d, are located within the base to assist in maintaining the divider wall 130 in an upright position when the organizer is in the in use position. This is more clearly shown in FIG. 6f which is a schematic diagram of the mechanical means 300 seen as a locking hinge for attaching the divider wall 130 to the base 122. The hinge is preferably attached to the base 122 using fastening means via a hole 302 in the hinge. The hinge is attached to the divider wall 130 via the plate 304 using fastening means such as screws.

In the upright position, the plate 304 is rotated 90 degrees from its current position in FIG. 6f and is locked in place via cables (not shown) connected to a cable connection point 306. Use of cable actuated locking hinges will be known by those skilled in the art. In order to release the divider wall from the upright position, a lever 308 is pulled in order to release the cables and to allow the hinge to return to the position shown in FIG. 6f. FIG. 6g provides a schematic diagram of an uninstalled cable actuated locking system 310 with the locking hinges connected via cables 312 to the lever 308.

In the stored position, as shown in FIG. 6b, the divider wall 130 is folded down so that it is parallel to the base 122 of the organizer 124. As can also be seen, the partitions are folded down as well leaving a single large storage area in the car trunk as if no organizer is present. FIG. 6c illustrates the car organizer in the stored position without the partitions for further clarification.

As shown in FIG. 6d, the divider wall may also include hooks 137 so that handles of bags, such as grocery bags, may be attached to prevent the bags from tipping during transport and therefore having their contents spill out.

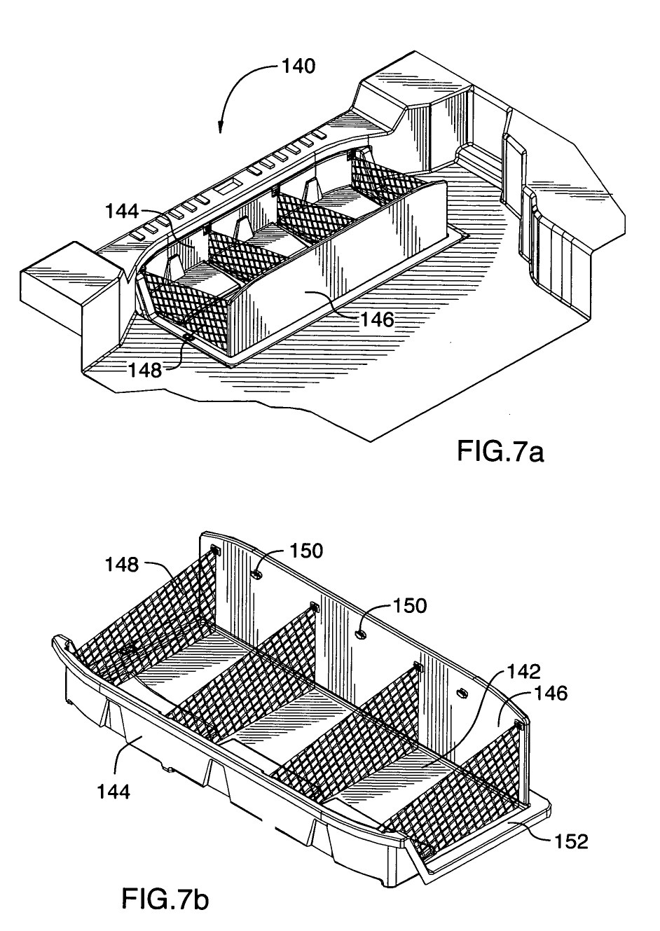

Turning to FIGS. 7a to 7b, yet a further embodiment of an organizer is shown. The organizer 140 is similar to the organizer of FIGS. 6a to 6e with the exception that the fixed wall 144 is integrated within the car trunk. Therefore, in this embodiment the requirement for fastening means to attach the organizer to the sill plate of the car trunk is removed.

As shown in FIG. 7b, the organizer 140 comprises a base 142 having a fixed wall 144 located along a long edge of the base 142. A divider wall 146 is pivotally mounted to the base a divider wall 146 for rotation between a stored position and an in use position where the divider wall is upright and is spaced apart from and generally parallel to the fixed wall. The organizer 140 also includes the partitions 148, bag hooks 150 and a ridge 152 as described above with respect to FIGS. 6a to 6e. In order to maintain the divider wall in the upright position when in the in use position, the organizer includes means for supporting the divider wall and for holding the divider wall in place.

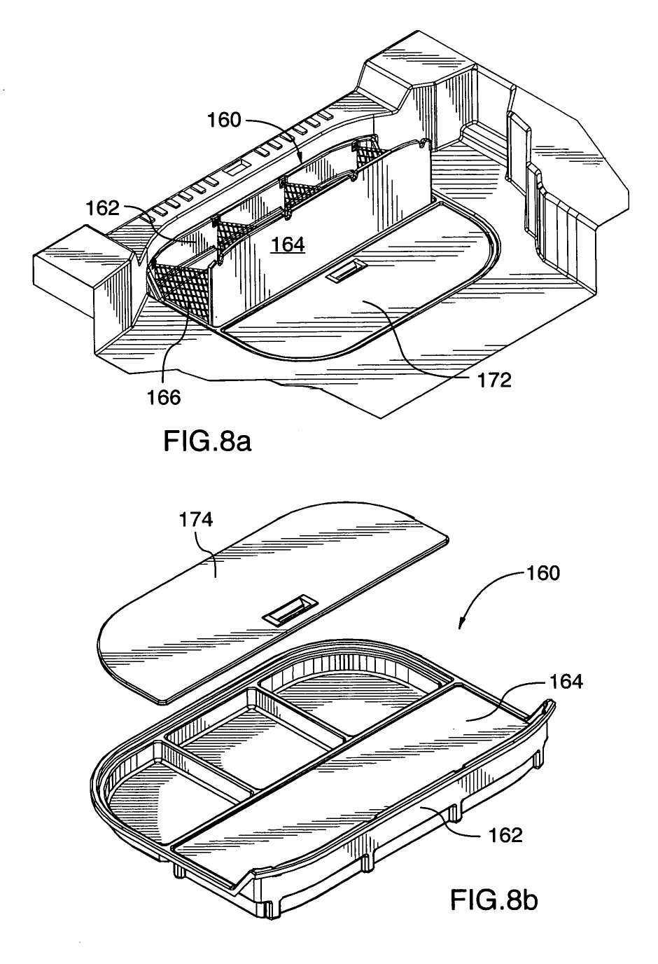

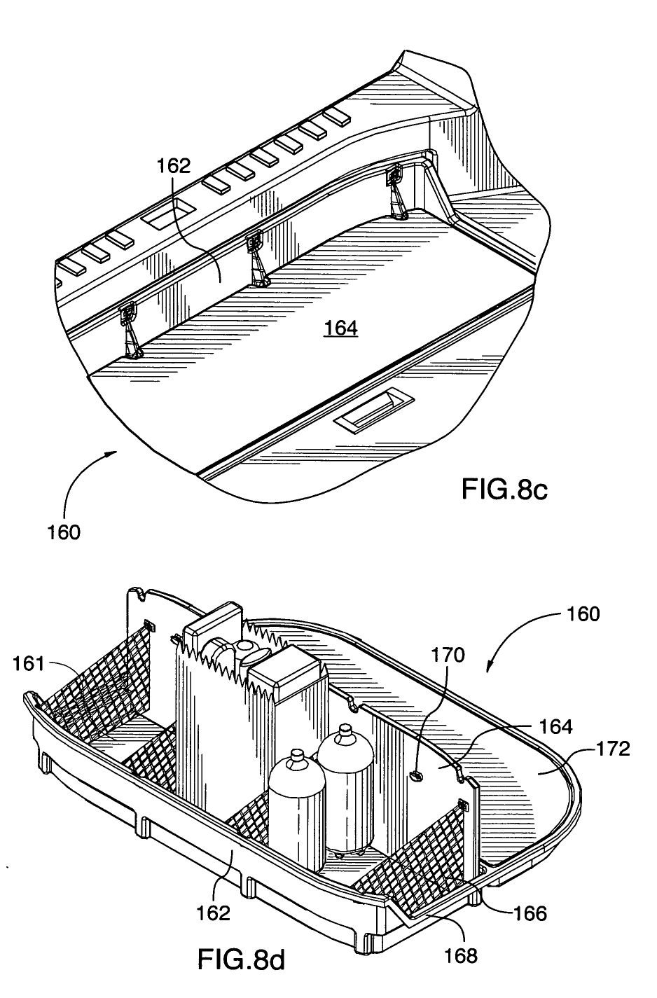

Turning to FIGS. 8a to 8d, a further embodiment of an organizer for storage space in an automobile is shown. Once again, this embodiment is directed for use in the trunk of an automobile. The organizer 160 comprises a base 161 having a fixed wall 162, located along a long edge of the base, that is integrated into the side of the car trunk. Alternatively, the fixed wall 162 may be attached, via fastening means such as a threaded screw, to the side of the automobile trunk. The organizer 160 further comprises a divider wall 164 which is pivotally mounted to the base 161 so that it may be rotated from the in use position to the stored position and vice versa. Use of the partitions 166, the ridge 168 and the bag hooks 170 are described above.

The organizer 160 is also integrated, as shown in FIG. 8a, within the floor of the automobile trunk unlike the embodiments described above which have the organizer resting atop the floor of the automobile trunk. Therefore, when the organizer 160 is in the stored position, the car trunk is returned to its original shape and size.

The organizer 160 may further comprises a separate storage area 172 which includes a removable cover 174 so that smaller items such as jumper cables and motor oil may be stored without taking up space in the trunk. Although shown as three separate sections, it will be understood that the storage area 172 may comprise any number of storage sections.

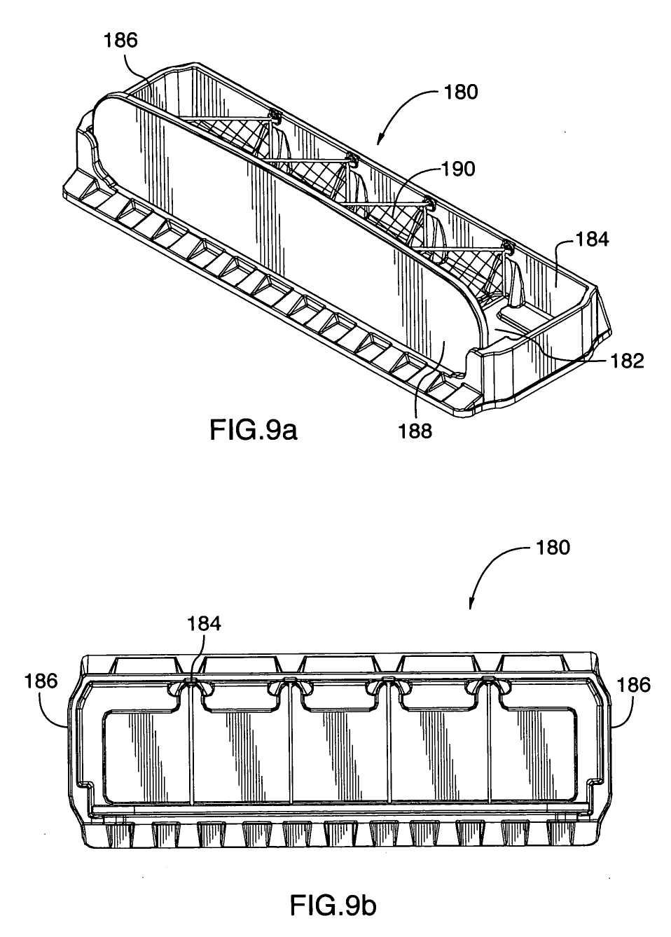

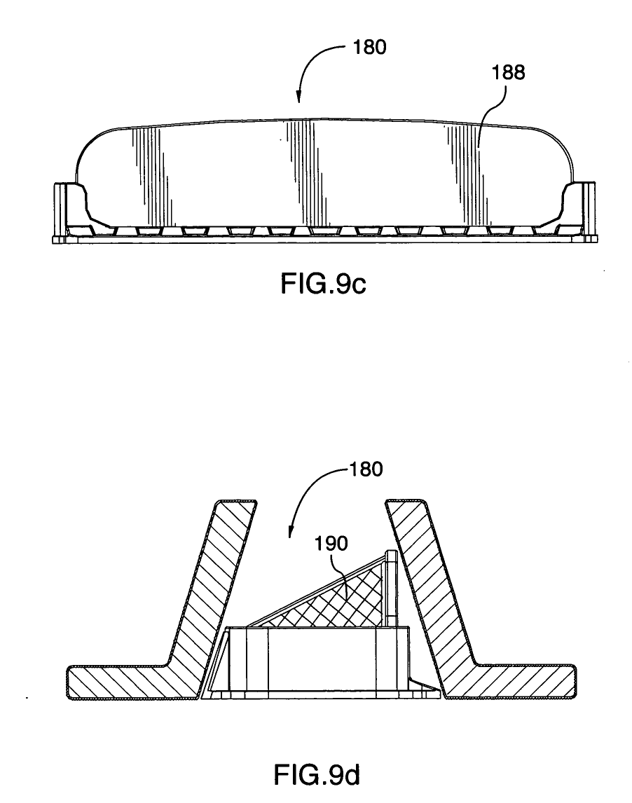

Turning to FIGS. 9a to 9d, yet another embodiment of an organizer is shown. The organizer 180 comprises a base 182 having a fixed wall 184 extending upwardly from the base along a long edge of the base 182. A couple of side walls 186, generally formed along with the fixed wall 184 are located parallel to each other at opposite ends of the fixed wall 184. A divider wall 188, is pivotally mounted generally parallel to and spaced apart from the fixed wall 184. Partitions, seen as net dividers, 190 are connected between the divider wall 188 and the fixed wall 184 to separate the storage space defined by the fixed wall 184, the side walls 186 and the divider wall 188 when the divider wall is upright and in the in use position. When in the stored position, the divider wall 188 lies flat along the base so that it does not take up any extra space.

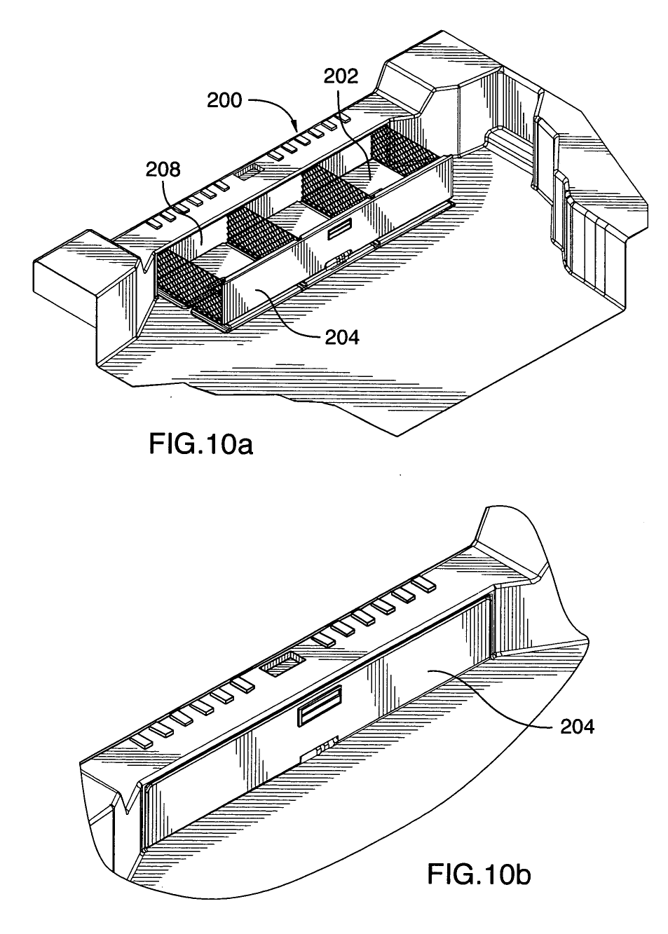

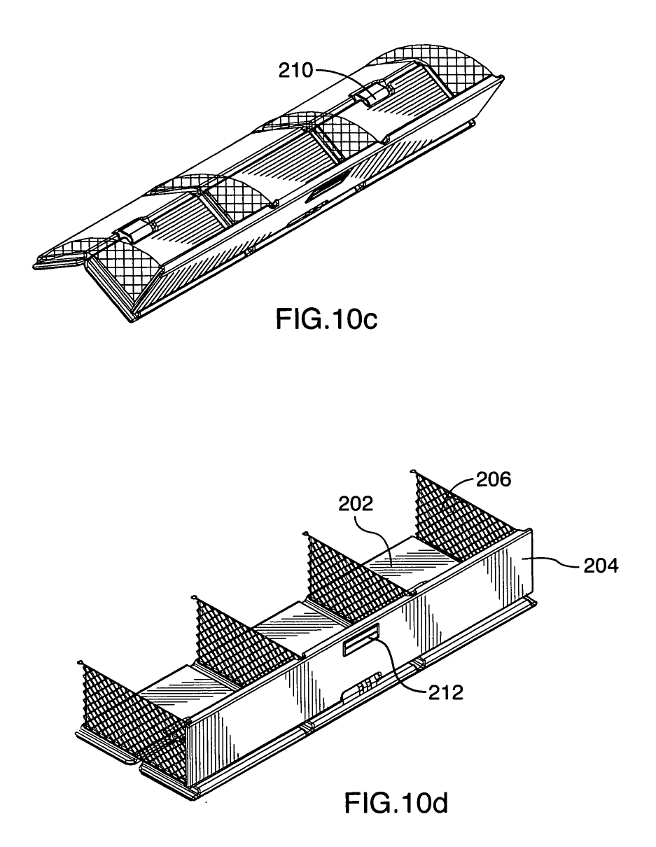

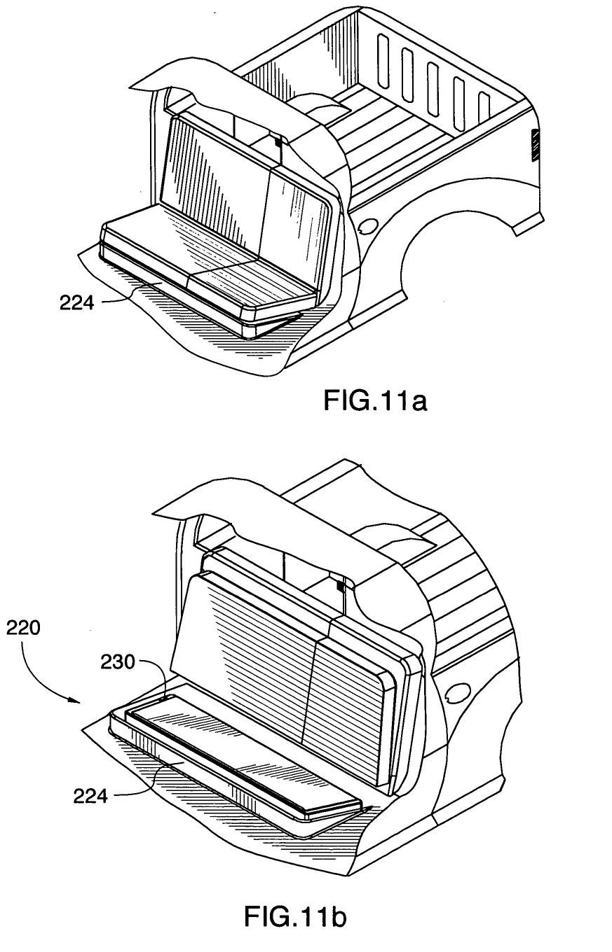

Turning to FIGS. 10a to 10d, yet a further embodiment of an organizer is shown. In this embodiment, the organizer 200 comprises a base 202 having a divider wall 204 attached along edge of the base 202. Partitions, seen as net dividers, 206 are attached between the divider wall 204 and a fixed wall 208 seen as the sill plate within the car trunk. In this manner, there is no requirement for the organizer to have a fixed wall connected along a long edge of the base as described with previous embodiment since the sill plates acts as the fixed wall for the organizer. In the in use position, the divider wall 204 is spaced apart from and generally parallel to the fixed wall 208. In the stored position, the divider wall is parallel to the base 202. Rather than being pivotally mounted along the base, the divider wall is simply attached to the base. However, the base 202 includes hinges 210 which allow it to fold when the base is being moved from the stored position to the in use position and vice versa. This may be more clearly seen in FIG. 10c. The stored position is more clearly shown in FIG. 10b. In order to move the organizer 200 from the stored position to the in use position, a handle 212 is located on the divider wall 204 for a user to grasp in order to pull the organizer out from the stored position.

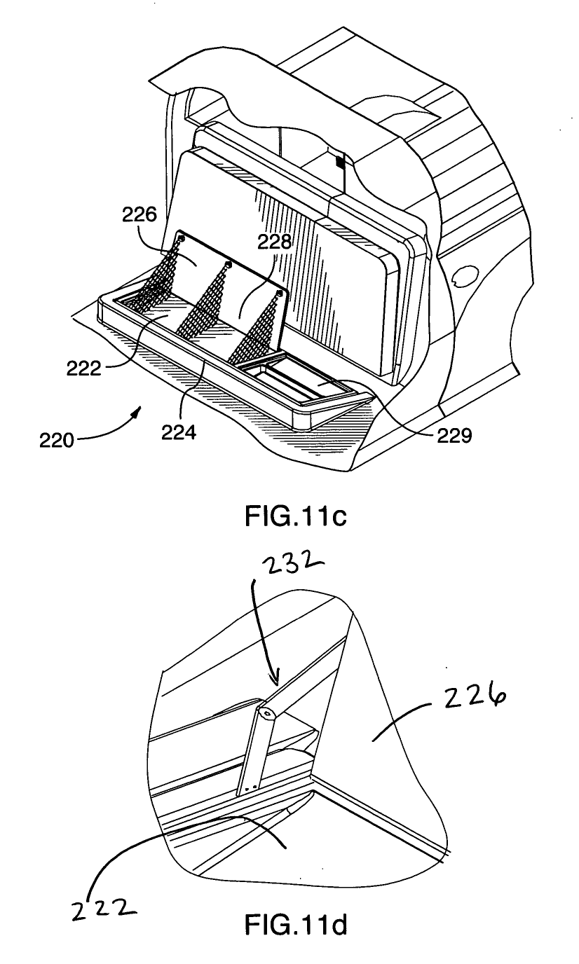

Turning to FIGS. 11a to 11d, yet a further embodiment of an organizer is shown. In this embodiment, the organizer is installed for use in the storage space underneath the cab seat of a vehicle such as a pick-up truck.

The organizer 220 comprises a base 222 which includes a fixed wall 224 extending upwardly from the base 222. A divider wall 226 is pivotally attached to the base 222 so that when it is upright and in an in use position, the divider wall 226 is spaced apart and generally parallel to the fixed wall 224. Alternatively, the divider wall 226 may be attached to the underside of the cab seat such that when a user lifts up the car seat to reveal the storage space, the divider wall 226 rotates from the stored position to the in use position. As with the other embodiments, partitions 228 are attached to the divider wall 226 and the fixed wall 224 in order to further separate the storage space provided in the underside of the cab seat of the pick-up truck. In this embodiment, the organizer also includes a side cargo pocket 229 adjacent the storage area defined by the fixed wall 224, the divider wall 226 and the partitions 228. It will be understood in other embodiments, the fixed wall and the divider wall may extend along the entire long edge of the base so that no side cargo pocket is present.

In order to prevent the divider wall 226 from pivoting without user intervention, a releasable latch/locking hinge 230, is located adjacent the divider wall which requires a user to depress the hinge before lifting up the divider wall 226 to reveal the storage area.

FIG. 11d provides an example of hinges 232 which may be used to pivotably attach the divider wall 226 to the base 222 such that the divider wall is hinged to the base at its side rather than its top as has been shown in previous embodiments.

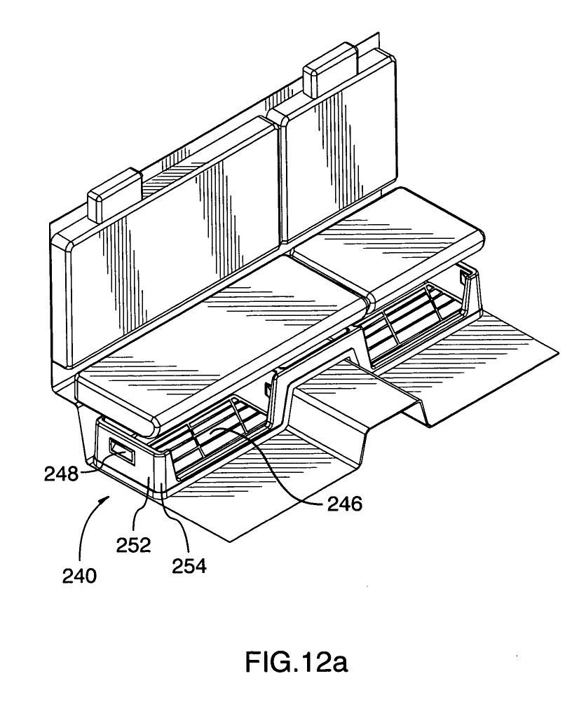

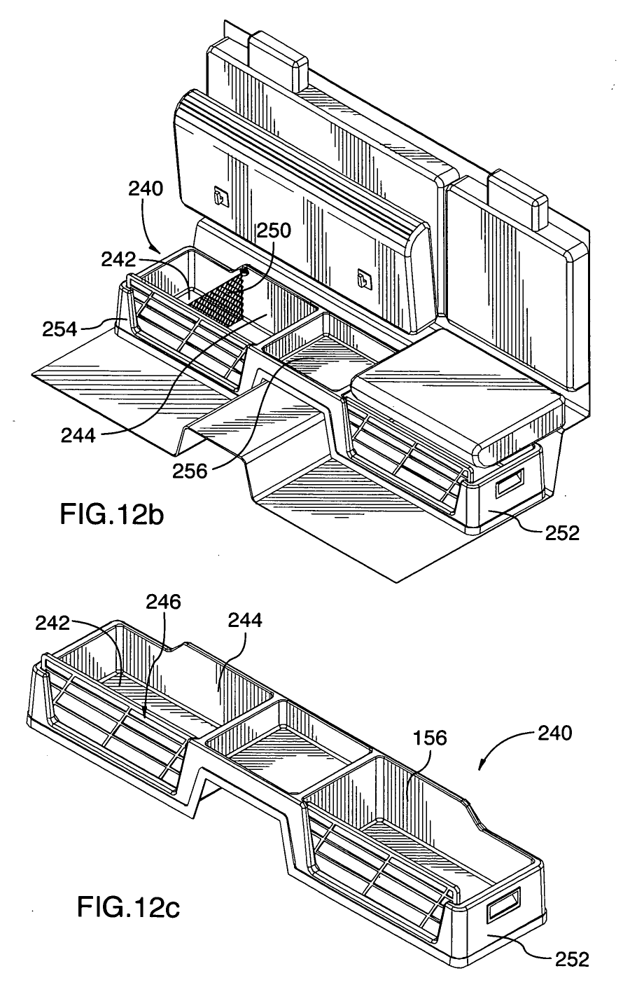

Turning to FIGS. 12a to 12c, another organizer for storage space in an automobile is shown. In this embodiment, the storage space is in the cab underseat of a vehicle.

The organizer 240 comprises a base 242 having a fixed wall 244 which extends upwardly from the base. A divider wall 246 is spaced apart from and generally parallel to the fixed wall and is hingedly connected to the base 242. The organizer 240 may be removable from its location by the use of grab handles 248 located on each side of the organizer 240. Partitions, seen as net dividers, 250 are also located between the fixed wall 244 and the divider 246 wall. In this embodiment, the organizer includes side walls 252 and support pillars 254 which provide support to the divider wall. The organizer 240 further includes means for maintaining the divider wall in an upright position when in the in use position. In order to access the storage space defined by the divider wall and the fixed wall, the cab seat of the vehicle is raised as shown in FIG. 12b. The organizer may include an extra storage section 256.

The organizer base is preferably manufactured from materials such as TPO, TPE, PP, PE and ABS. The base is preferably made with via a process such as injection molding, compression molding, thermoforming, or blow molding.

The divider wall is preferably rigid and spans the width of the vehicle but may be varying widths depending on the options integrated in the organizer. The divider wall is preferably manufactured from a wood, a wood by-product or plastics similar to the base. The divider wall may be manufactured from a process such as compression molding, blow molding, injection molding or thermoforming (single or twin sheet). The means for housing the partitions (such as net hooks or slots) may be over-molded or separately attached to the divider wall. The divider wall may also be covered with materials such as carpet, thermoset rubber, brushed metal or other vehicle integrating materials in order to provide a more consistent look.

The partitions used to separate the area (defined by the divider wall, the base and the fixed wall) may be rigid or flexible. Rigid materials such as polypropylene (PP), polyethylene (PE), Acrylonitrile-butadiene-styrene (ABS) are contemplated for the rigid partitions while flexible materials such as nylon nets, elasticized nets, fabric, may also be used for the flexible partitions.

It will be understood that the means for maintaining the divider wall in an upright position in embodiments with support pillars is preferably snap clips located on the support pillars. In embodiments where there are no support pillars, the means for maintaining the divider wall in an upright position is preferably cable activated locking hinges.

Although described as being located on the support pillars, the means for keeping the divider wall in an upright position in the in use position, may be located in other locations. Furthermore, although described as spring clips, the locking mechanism may be a spring loaded pin at the hinge point or any similar arrangement like a spring clip, toggle, cam, latch, and also a locking device at the hinge point.

The car trunk organizer may also be installed in the vehicle by different methods such as a set of clips fastening the organizer to the rear wall and/or trunk floor using existing mounting points in the vehicle or creating new mounting points. The organizer may also be attached to existing cargo tie down loops/hooks in the vehicle. The organizer can also be designed to be integral part of the sill plate thereby replacing current sill plates. The organizer could also be attached to or fixed in place by the spare tire cover or replace the spare tire cover. The vehicle geometry may be used to position/restrain the organizer in place.

Additional features that can be incorporated into the organizer are such things as a golf bag cradle, side pockets (to hold things like pop/milk jugs or miscellaneous items), access to cargo tie downs (either existing in vehicle or part of the organizer), and integrated lighting. Although shown as evenly spaced partitions, it will be understood that if the location of the means for holding the partitions may be altered at the time of manufacture in accordance with predefined specifications. Furthermore, the divider wall may be split 60/40 or 50/50, etc to align with the split in the rear seat.

Furthermore, although generally described as a fixed wall attached to the base, it will be understood that this is for installing the organizer in existing automobiles. Alternatively, the organizer may be integrated within the car so that fixed parts within the car such as the sill plate may be used as the fixed wall. This reduces the amount of materials necessary to manufacture the organizer.

Alternatively, the organizers may be manufactured with handles for easy removal of the organizer from the car when the full capacity of the storage space in the car is required for the transport of larger items. Furthermore, the organizer may also comprises a pocket which allows for side storage capabilities behind the wheel wells.

The above-described embodiments of the present invention are intended to be examples only. Alterations, modifications and variations may be effected to the particular embodiments by those of skill in the art without departing from the scope of the invention, which is defined solely by the claims appended hereto.

1. A collapsible organizer for dividing a vehicle storage area of a vehicle into at least two storage compartments comprising:
a base;
a fixed wall;
a divider wall, pivotally mounted to said base for rotation between a stored position against said base and an upright position spaced apart from and generally parallel to said fixed wall;
at least two partitions extending between said fixed wall and said divider wall; and
means for locking said divider wall in said upright position.

2. The organizer of claim 1 wherein at least two of said partitions are adjacent opposite ends of said organizer, thereby acting as end walls.

3. The organizer of claim 2 wherein said partitions are detachable.

4. The organizer of claim 3 wherein said partitions are flexible.

5. The organizer of claim 4 wherein said partitions are made out of netting.

6. The organizer of claim 1 wherein said fixed wall is integrated along a long edge of said base.

7. The organizer of claim 1 wherein said fixed wall is a sill plate of said vehicle.

8. The organizer of claim 1 further comprising a secondary storage area.

9. The organizer of claim 8 wherein said secondary storage area includes a cover.

10. The organizer of claim 1 further including support pillars for supporting said divider wall in said upright position.

11. The organizer of claim 1 wherein said means for locking said divider wall in said upright position are snap clips or a locking hinge.

12. The organizer of claim 1 further comprising means for attaching said organizer to a wall of an automobile trunk.

13. The organizer of claim 1 further comprising means for attaching said organizer to an automobile floor.

14. A collapsible organizer for dividing a vehicle storage area into at least two storage compartments comprising:
a base having hinges for rotation between a stored position and an in use position;
a fixed wall;
a divider wall, mounted to said base;
means for connecting said base to said vehicle storage area; and
at least two partitions extending between said fixed wall and said divider wall;
wherein when said organizer is in said in use position, said divider wall is spaced apart from and generally parallel to said fixed wall and when said organizer is in said stored position said divider wall is adjacent said base and said fixed wall.
